(19) United States
(12) Patent Application Publication
(10) Pub. No.: US 2006/0245209 A1
(43) Pub. Date: Nov. 2, 2006

(54) Hybrid backlight apparatus

(75) Inventors: Ho Seop Jeong, Sungnam (KR); Kiyoyuki Kawai, Suwon (KR); Jin Jong Kim, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/414,294

(22) Filed: May 1, 2006

(30) Foreign Application Priority Data
May 2, 2005 (KR) 10-2005-36884

(51) Int. Cl. G01D 11/28

(52) U.S. Cl. 362/612; 362/614; 362/27

(57) ABSTRACT

The present invention relates to a backlight apparatus for a Liquid Crystal Display. The backlight apparatus includes a main light source for generating white light and a monochromatic light source for generating monochromatic light to compensate the color temperature of the white light. The backlight further includes a light mixing region for mixing the white light with the monochromatic light to form mixed light with compensated color temperature and a reflection plate disposed underneath the light mixing region. The invention provides the monochromatic light source in addition to the fluorescent lamp, widening the color expression range and effectively adjusting the color temperature, thereby enabling natural color expression.

### CLAIM OF PRIORITY

This application claims the benefit of Korean Patent Application No. 2005-36884 filed on May 2, 2005, in the Korean Intellectual Property Office, the disclosure of which is incorporated herein by reference.

### BACKGROUND OF THE INVENTION

1. Field of the Invention

The present invention relates to a backlight apparatus for a Liquid Crystal Display (LCD), and more particularly, to a hybrid backlight apparatus for an LCD, in which a monochromatic light source is added to a fluorescent lamp to widen a color expression range and effectively adjust a color temperature, thereby enabling natural color expression.

2. Description of the Related Art

In general, a Liquid Crystal Display (LCD) includes a pair of glass plates and liquid crystal injected into each pixel between the glass plates. The LCD displays an image as the arrangement of the liquid crystal molecule of each pixel is altered when supply voltage is applied to the electrodes of the upper and lower glass plates.

Unlike a Cathode Ray Tube (CRT), a Plasma Display Panel (PDP) and a Field Emission Display (FED), the LCD does not emit light by itself, and thus requires a backlight apparatus for a light source.

FIG. 1 is an exploded perspective view of a backlight apparatus for an LCD using a fluorescent lamp, according to the prior art.

The prior art backlight apparatus 10, which adopts an edge irradiation method, includes a light guide plate 12 made of transparent resin, fluorescent lamps disposed at both edges of the light guide plate 12 and a pair of reflecting mirrors 16 for supporting the fluorescent lamps 14 while reflecting the light from the fluorescent lamps 14 into the light guide plate 12.

Typically a Cold Cathode Fluorescent Lamp (CCFL) is used for the fluorescent lamp 14, in which highly efficient phosphors using rare earth elements (Y, Ce, Tb, etc.) are applied on the inner wall thereof to be activated and emit light when hit by electrons.

At this time, underneath the light guiding plate 12, reflection patterns (not shown) and a reflection plate (not shown) are installed to send light from the light guiding plate 12 to an LCD panel 20 above, thereby backlighting the LCD panel 20. The reflection plate preferably has minute patterns formed thereon or is a Lambertian sheet. Also, there may be minute relief patterns formed on the bottom surface of the light guide plate 12.

However, the prior art fluorescent lamp-based backlight apparatus 10 has several problems as explained hereinbelow.

FIG. 2 is a chromaticity diagram showing a color expression range and a representative color temperature of the prior art backlight apparatus using the fluorescent lamps.

A chromaticity diagram is aimed to mark general visual colors of light source or colors of objects on a coordinate plane, in which stimulus values of three primary colors, i.e., red, green and blue are represented by numerical values. Given that a light emission spectrum of an arbitrary light source is represented by Q(λ), a stimulus value for each color is yielded by multiplying Q(λ) by a color matching function corresponding to the spectral sensitivity of a visual sensor which perceives a specific color. In such a chromaticity diagram, the white light region exists in a range defined by X=0.21˜0.49 and Y=0.2˜0.46.

In the case of the backlight apparatus 10 in FIG. 1, the output light P₁ has a color temperature of 10000K, and color coordinates of X=0.292, Y=0.315, as shown in FIG. 2. On the other hand, daylight has a color temperature of 6500K and color coordinates of X=0.31, Y=0.32. Therefore, the output light P₁ of the fluorescent lamp is leaning more toward blue than daylight, giving a cold feeling.

The cause behind the above observation can be explained with reference to the light source spectrum of a fluorescent lamp used for a prior art backlight apparatus in FIG. 3.

As shown in FIG. 3, the fluorescent lamp has the greatest energy at the green wavelength G and has the least energy at the red wavelength R. In addition, the peak of the red wavelength R is lower than that of the red filter, and shifted toward green more than the red filter. Therefore, as shown in FIG. 2, the output light P₁ of the fluorescent lamp is shifted toward green and blue, providing a screen with a cold feeling overall. In addition, as the output light of the fluorescent lamp is filtered, undesired stray light may be mixed together due to the wide range of the filter, thereby resulting in a narrow color expression range.

In the case of an LCD, liquid crystal is manipulated to obtain white light having an improved color temperature. That is, the orientation of the liquid crystal molecule is adjusted to decrease the amount of the green and blue light except the red light, thus adjusting the white light to obtain a desired color temperature. However, this procedure results in blocking parts of light, i.e., the green light and the blue light, decreasing the overall output of light and lowering luminance.

### SUMMARY OF THE INVENTION

The present invention has been made to solve the foregoing problems of the prior art and it is therefore an object of the present invention to provide a hybrid backlight apparatus capable of widening a color expression range and effectively adjusting a color temperature of white light while not decreasing the amount of light or lowering reliability.

In order to realize the above object, the hybrid backlight apparatus according to the present invention is additionally provided with a monochromatic light source such as a monochromatic Light Emitting Diode (LED) for generating monochromatic light to adjust the color coordinates of the fluorescent lamp that is a white light source for generating white light.

In this specification, “white light” refers to light close to natural daylight including various wavelengths but does not necessarily refer to daylight only. In addition, “monochromatic light” refers to light concentrated in any one wavelength and does not refer to light having only one wavelength.

According to an aspect of the invention for realizing the object, there is provided a hybrid backlight apparatus comprising: a main light source for generating white light; a supplementary light source for generating monochromatic light to compensate color temperature of the white light of the main light source; a light mixing region for mixing the white light with the monochromatic light to form mixed light with compensated color temperature; and a reflection plate disposed underneath the light mixing region.

In the hybrid backlight apparatus according to the present invention, the white light has a color temperature ranging from 20000K to 7000K, and the supplementary light source generates the supplementary light to have a color temperature ranging from 12000K to 5000K. Alternatively, in the event that the amount of light for each color is adjusted at an LCD or a monochromatic light of green is added, the color temperature may be adjusted to reach up to 4000K, within the range that does not deviate from the Planckian Locus.

In the hybrid backlight apparatus according to the present invention, the main light source comprises a fluorescent lamp and the monochromatic light comprises red light. In addition, the supplementary light source comprises at least one selected from a group including a light emitting diode, a laser diode and a monochromatic filter lamp.

The output of the supplementary light source is 5% to 20% of the output of the main light source and the output is adjustable to freely change the color temperature.

At this time, the hybrid backlight apparatus may further include a second supplementary light source for generating green light to be mixed with the mixed light in order to obtain a color temperature desired for individual or place while maintaining white balance. At this time, the mixed light can be adjusted to have a color temperature shifted more toward red and green regions than the white light. The second supplementary light source may comprise at least one selected from a group including a light emitting diode, a laser, a laser diode, and a monochromatic filter lamp.

In addition, in the hybrid backlight apparatus according to the present invention, the light mixing region comprises a light guide plate, and the main light source and the supplementary light source are disposed at an edge of the light guide plate. At this time, the main light source and the supplementary light source may be disposed at different edges of the light guide plate. Also, the main light source and the supplementary light source may be disposed at the same edge of the light guide plate.

Moreover, the hybrid backlight apparatus according to the present invention may further comprise a housing which forms the light mixing region along with the reflection plate, and in which the main light source and the supplementary light source are disposed. At this time, the main light source may be supported by a side wall of the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a prior art backlight apparatus using fluorescent lamps;

FIG. 2 is a chromaticity diagram showing a color expression range and the most representative color temperature of the prior art backlight apparatus using the fluorescent lamps;

FIG. 3 is a graph showing a spectrum of light source of the fluorescent lamp adopted in the backlight;

FIG. 4 is a plan view illustrating an overall constitution of a hybrid backlight apparatus according to a first embodiment of the present invention;

FIG. 5 is an exploded perspective view illustrating the backlight apparatus in FIG. 4 together with an LCD panel;

FIG. 6 is a graph showing a spectrum of light source of LEDs as an example of monochromatic light source;

FIG. 7 is a chromaticity diagram showing a range of color temperature of the hybrid backlight apparatus according to the present invention;

FIG. 8 is a chromaticity diagram illustrating the color expression range of the backlight apparatus of the present invention in comparison with the color expression range of the prior art backlight apparatus;

FIG. 9 is an exploded perspective view illustrating an overall constitution of a hybrid backlight apparatus according to a second embodiment of the present invention; and

FIG. 10 is a sectional view taken along the line X-X.

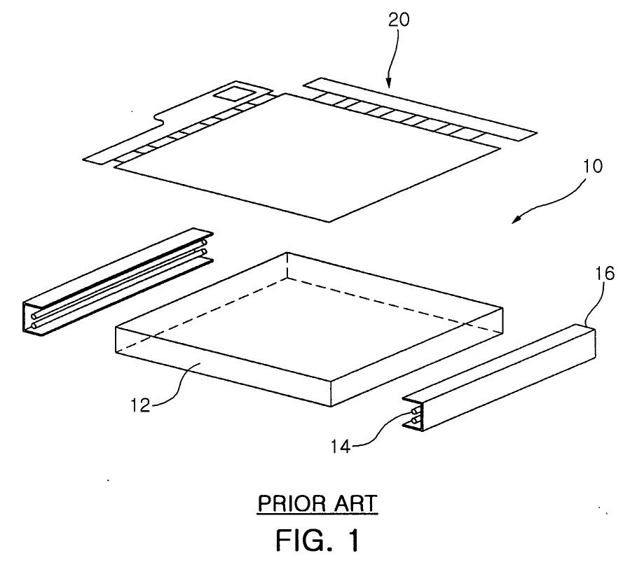

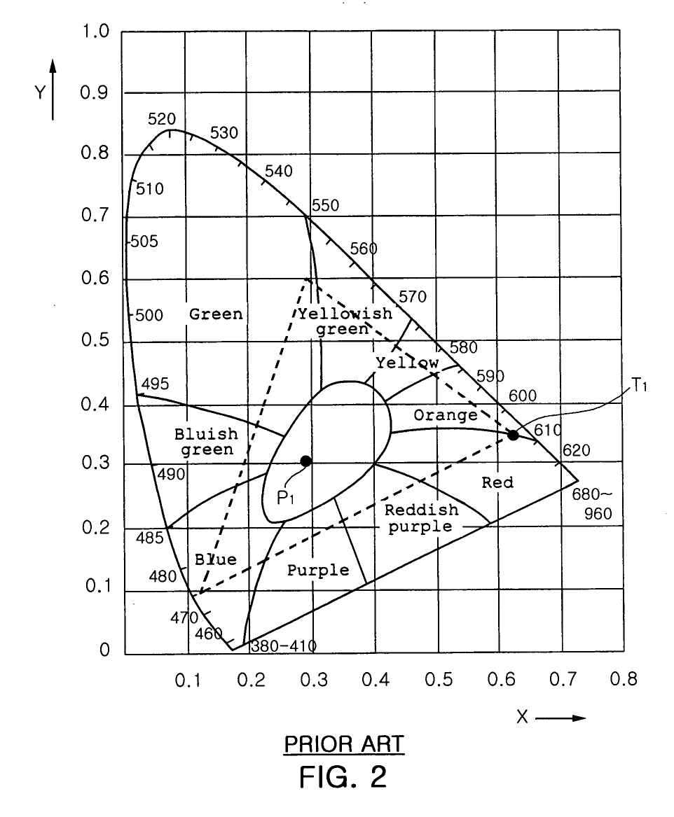

### DETAILED DESCRIPTION OF THE PREFERRED EMBODIMENT

Preferred embodiments of the present invention will now be described in detail with reference to the accompanying drawings.

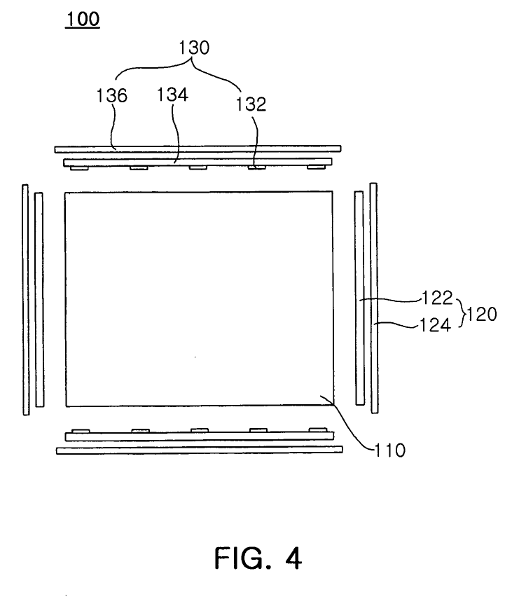

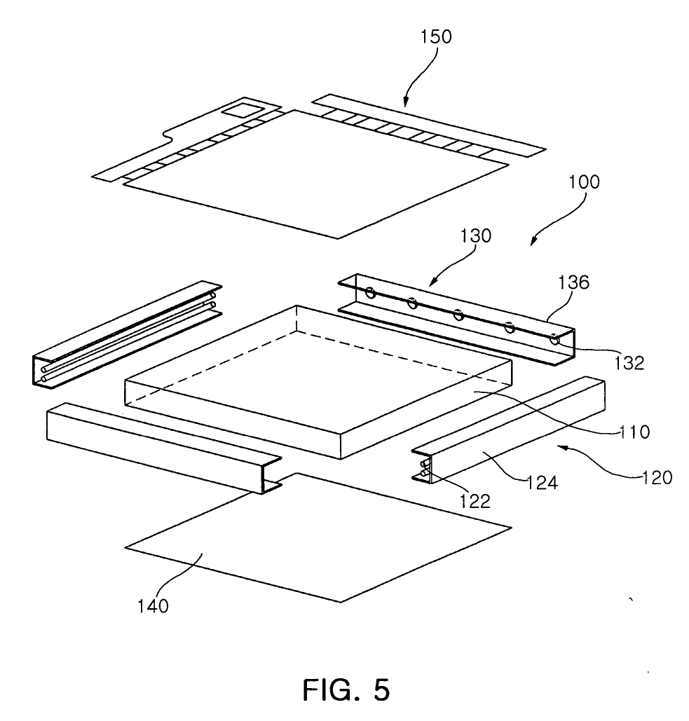

FIG. 4 is a plan view showing an exploded constitution of a hybrid backlight apparatus according to a first embodiment of the present invention, and FIG. 5 is an exploded perspective view of the hybrid backlight apparatus in FIG. 4 together with an LCD panel.

As shown in FIGS. 4 and 5, the backlight apparatus 100 according to the present invention adopts an edge irradiation method, and includes a light guide plate 110 made of transparent resin, a pair of white light sources 120 for the main light source disposed at a pair of opposed edges of the light guide plate 110 and a pair of monochromatic light sources 130 for a supplementary light source disposed at the other pair of opposed edges.

The light guide plate 110 is a plate member having a predetermined thickness, composed of transparent acryl, Polymethylmethacrylate (PMMA), plastic or glass.

Each white light source 120 includes a lamp 122 and a reflection mirror 124 which reflects light from the lamp 122 into the light guide plate 110. Although not shown in the diagram, there is a connection part for supporting and providing electric connection to the lamp 122.

The lamp 122 is a fluorescent lamp and preferably a cold cathode fluorescent lamp, in which highly efficient rare earth elements (Y, Ce, Tb, etc.) are applied on the inner wall to emit light when hit by electrons. The reflection mirror 124 is composed of material having high reflectivity, preferably metal or has material of high reflectivity coated thereon.

Each monochromatic light source 130 includes a plurality of monochromatic LEDs 132, a substrate 134 for providing electric connection while supporting the LEDs and a reflection mirror 136 for reflecting light from the LED 132 into the light guide plate 110.

The LEDs 132 are used for adjusting the color temperature of the lamp 122, close to daylight. To be specific, the color coordinates of the white light from the lamp 122 are shifted toward blue and green, and thus the LEDs 132 are used to adjust the shifted color coordinates to move toward those of daylight (X=0.31, Y=0.32). Therefore, red LEDs are used for the LED 132.

At this time, the appropriate output of all LEDs 132 is preferably 5% to 20% of the output of the lamp 122. In general, a lamp 122 has a color temperature ranging from 20000K to 7000K, but additional use of the LED 132 allows a color temperature ranging from 12000K to 5000K.

Besides the above described red LED, a red laser, a laser diode and red-filtered lamp (i.e., a lamp including a red filter) of appropriate wavelength range can be adopted as the monochromatic light source 130 to adjust the color coordinates of the white light generated by the lamp 122.

At this time, in order not to allow any dark spaces, the plurality of red LEDs 132 can be spaced apart from each other in a predetermined interval and disposed apart in a predetermined distance from the light guide plate 110 or lenses capable of widening the radiation angle can be used.

The substrate 134 is preferably a metal substrate which can provide electric connection to the LEDs 132 and draw out the heat generated from the electric connection. The reflection mirror 136 is made of material of high reflectivity, preferably metal, or can have material of high reflectivity coating thereon so as to send the light from the LEDs 132, i.e., the monochromatic light into the light guide plate 110.

In addition, a reflection plate 140 is installed underneath the light guide plate 110. The reflection plate 140 sends the light from the lamps 122 and the LEDs 132 in the light guide plate 110 upward to an LCD panel 150, thereby backlighting the LCD panel 150. The reflection plate 140 preferably has minute patterns thereon or has a Lambertian surface. Alternatively, there may be minute relief patterns and/or ink dot patterns formed on the underside of the light guide plate 110.

The white light source 120 has been described as a pair of light sources disposed at a pair of opposed edges of the light guide plate 110, but it may be disposed at only one edge of the light guide plate 110. In the same fashion, the monochromatic light source 130 can also be disposed at only one edge of the light guide plate 110. Alternatively, the monochromatic light source 130 can be disposed on the same edge of the light guide plate 110 as the white light source 120.

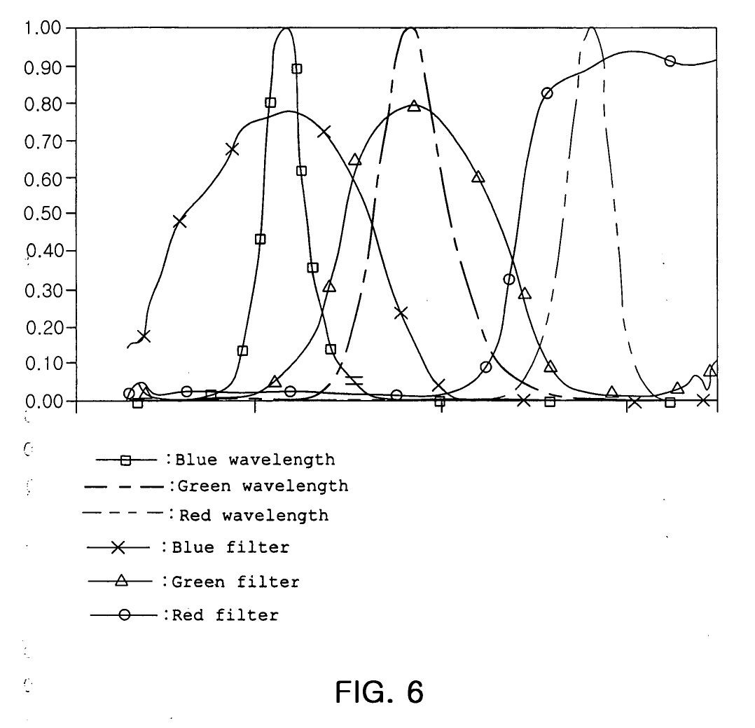

FIG. 6 is a graph showing a light source spectrum of the LED adopted in the present invention.

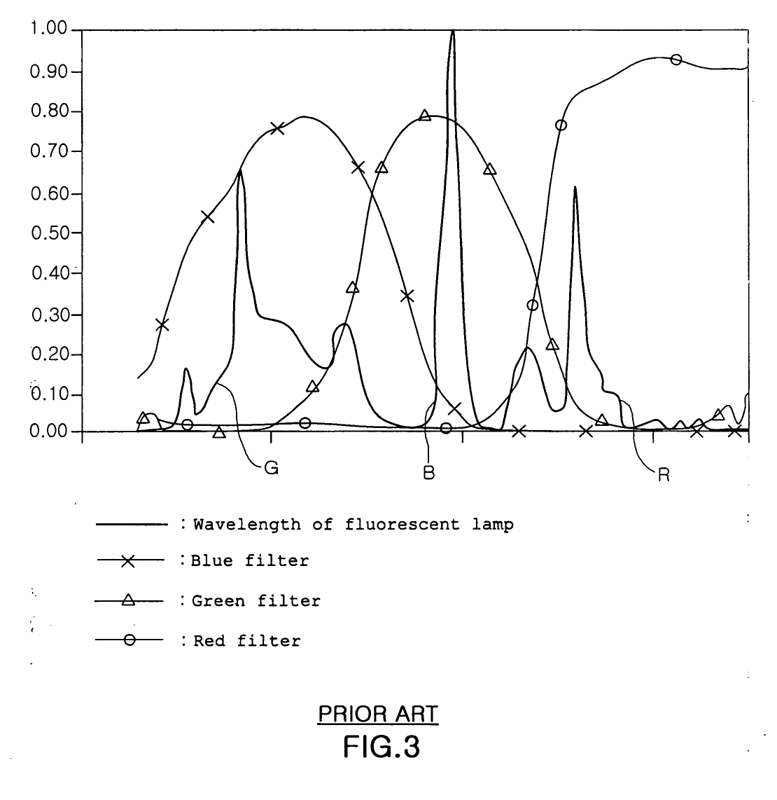

As shown in FIG. 6, the red LED wavelength R has its peak higher than that of the red filter, and thus can compensate for the red wavelength light deficient in the white light of the fluorescent lamp 122 shown in FIG. 3. Accordingly, in the backlight apparatus 100 of the present invention, the color temperature and the color coordinates of the light incident onto the LCD panel 150 become shifted toward the red color region, thus giving less cold feeling overall, close to daylight.

At this time, the amount of light of the red LED 132 can appropriately be adjusted to change the color temperature of the mixed light from 10000K to 4000K. In the mixed light for obtaining such a color temperature range, the output range of the red LED 132 is 8% to 15% of the output of the lamp when the color temperature of the lamp 122 is 10000K. The output range of the LED 132 necessary for obtaining the color temperature of daylight (6500K) is about 10% of the output of the lamp 122 when the color temperature of the lamp 122 is 10000K.

Although not shown, another monochromatic light source, for example, a green color light source may additionally be adopted as a second supplementary light source. Thereby, the color temperature of the mixed light of the backlight can be adjusted to a greater range, i.e., up to 4000K.

In this case, the green color light source can be disposed between the red LEDs 134 or beside the lamp 122, and the examples thereof include an LED, a laser, a laser diode and a lamp having a monochromatic filter of an appropriate green wavelength range.

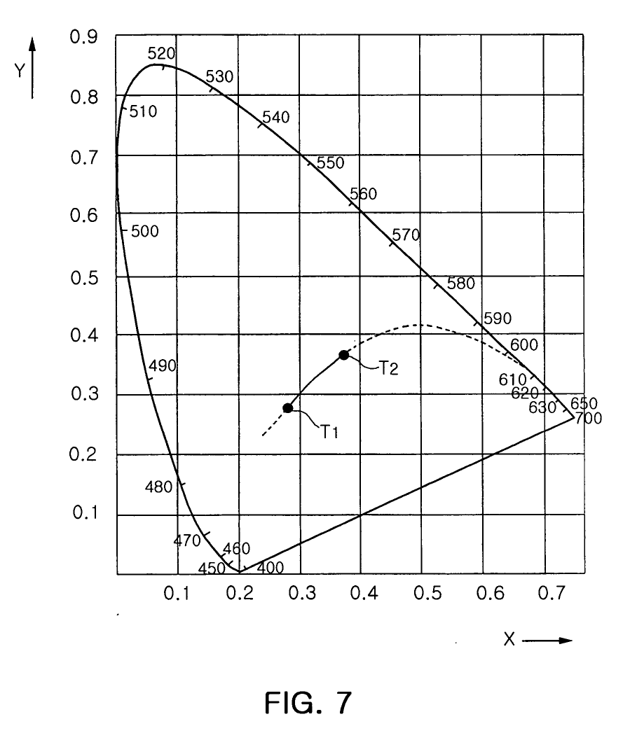

FIG. 7 is a chromaticity diagram showing a color temperature range of the hybrid backlight apparatus according to the present invention.

With reference to FIG. 7, the hybrid backlight apparatus according to the present invention has a color temperature ranging from T1(12000K) to T2(5000K). Here, the coordinates for T1 are X=0.28, Y=0.28, and the coordinates for T2 are X=0.37, Y=0.37.

Now, an experiment on the color temperature of the mixed light with the combination of the fluorescent lamp and the red LED, according to the present invention, is described as follows.

The fluorescent lamp for the main light source has an output of 20 W, and the white light emitted from the fluorescent lamp alone has a color temperature of about 9000K, with color coordinates of X=0.292, Y=0.315. On the other hand, the red LED for the supplementary light source has the wavelength and the peak as shown in FIG. 6 and an output of 8% of that of the fluorescent lamp.

The light obtained from the combination of the above fluorescent lamp and the red LED has a color temperature of about 6800K and color coordinates of X=0.319, Y=0.308. The light with these characteristics are similar to daylight, and has a color expression range shifted toward the right side of the graph or the red color region.

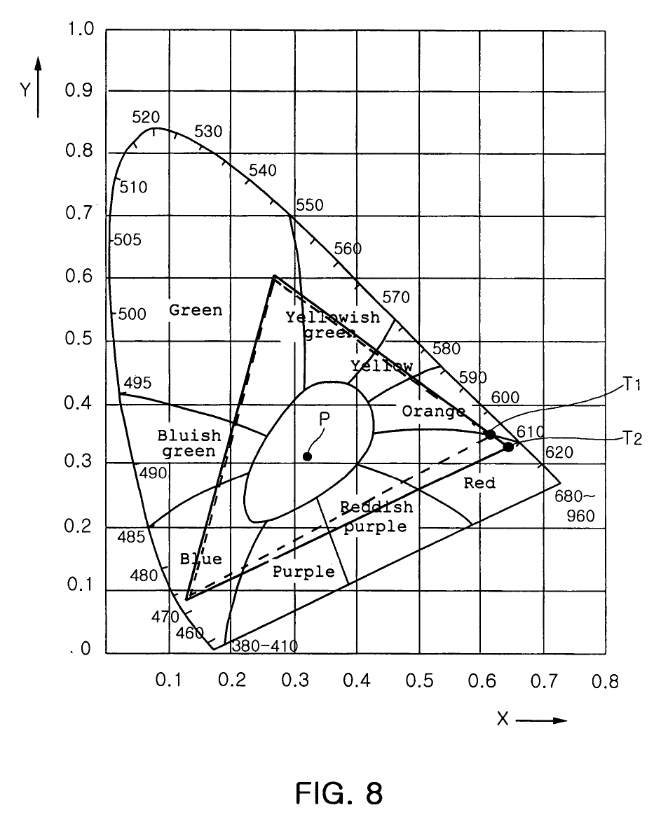

Compared with the fluorescent lamp, this light exhibits about 5% of improvement in color reproducibility. The color expression range of the fluorescent lamp is shown in a dotted line in FIG. 8 which is about 75% of what is stipulated by National Television System Committee (NTSC), and 80% of what is stipulated by NTSC with additional red LEDs. Thereby, the color range can be widened beyond the dotted line of the fluorescent lamp, enabling natural color expression. That is, the present invention allows more natural color expression in the red color region, compared with use of the fluorescent lamp only.

In the above experiment, the output of the red color light source was set 8% of the output of the fluorescent lamp, but the output can further be increased to obtain the color temperature of daylight, i.e., 6500K or even beyond. In addition, with an additional green color light source, it will be easier to obtain the color temperature of daylight and even obtain a color temperature up to 4000K.

In the meantime, a comparison is made between the color characteristics of the prior art fluorescent lamp and those of the hybrid backlight of the present invention.

In FIG. 8, T1 is the peak value of the red color (X=0.636, Y=0.336) in the color expression range of the prior art fluorescent lamp, and T2 is the peak value (X=0.649, Y=0.328) realized by additional provision of the monochromatic light of red.

As shown in FIG. 8, the provision of the monochromatic light source of red results in a greater range than that of the fluorescent lamp.

As a result, the color temperature and the color coordinates of the white mixed light from the hybrid backlight of the present invention is shifted more toward the red color region than the prior art fluorescent lamp, giving a less cold feeling overall and is closer to daylight with a wider color expression range. Therefore, the present invention allows more natural color expression.

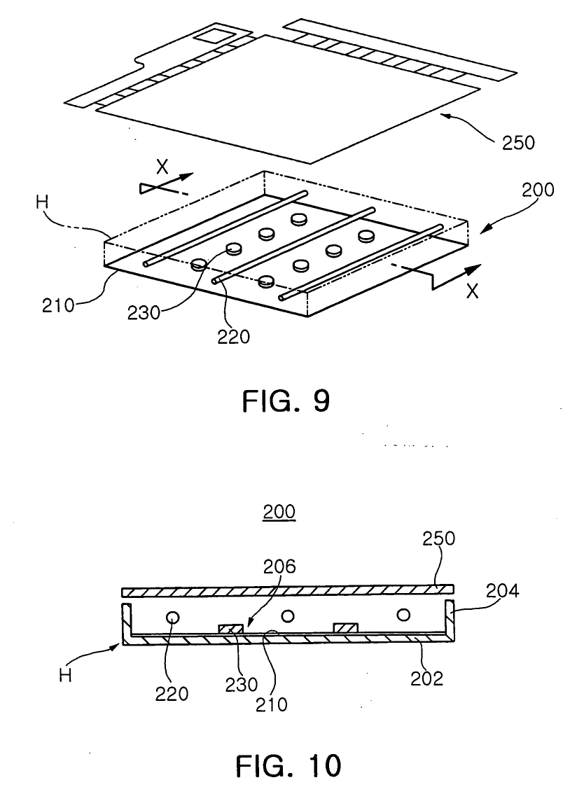

FIG. 9 is an exploded perspective view illustrating an overall constitution of a hybrid backlight apparatus according to a second embodiment of the present invention, and FIG. 10 is a sectional view of the hybrid backlight apparatus of FIG. 9.

With reference to FIGS. 9 and 10, the hybrid backlight apparatus 200 according to the second embodiment of the present invention is a direct illumination type, including a reflection plate 210, a plurality of white light sources 220 disposed above the reflection plate 210 and monochromatic light sources 230 disposed between the white light sources 220.

The backlight apparatus 200 further includes a housing H as a space for receiving the above constituents therein. The housing H includes a bottom surface 202 for supporting the reflection plate 210 and side walls 204 for supporting the white light sources 220. The inner surface of the side wall 204 may have a reflection surface so as to reflect the light generated from the white light source 220 and the monochromatic light source 230.

The reflection plate 210 is configured to reflect upward the light from the white light source 220 and the monochromatic light source 230. In particular, it is preferable that the upper surface of the reflection plate 210 is a Lambertian surface or has minute relief patterns formed thereon.

The reflection plate 210 uniformly reflects the light from the white light source 220 and the monochromatic light source 230 to the LCD panel, thereby backlighting the LCD panel 240.

Thereby, the lights from the white light source 220 and the monochromatic light source 230 are mixed in the inner space 206 of the housing H formed by the side walls 204 of the housing and the reflection plate 210. In other words, there is formed a light mixing region in which the monochromatic light is mixed with the white light to adjust the color temperature of the white light.

The white light source 220 is, for example, a fluorescent lamp and preferably, uses a CCFL. Rare earth elements (Y, Ce, Tb, etc.) are applied on the inner wall of the lamp so that when hit by electrons, they are activated to emit light.

The monochromatic light source 230 is disposed in such a way that does not undermine the mechanical and optical position of the white light source 220. For the monochromatic light source 230, a monochromatic LED such as a red LED is used.

The specifics of the white light source 220 and the monochromatic light source 230 are identical to those of the first embodiment, and hence no further explanation is necessary.

Similar to the first embodiment, the second embodiment also enables adjusting the color coordinates and the color temperature and increasing the color expression range. Such effects are also identical to the aforementioned ones, and thus additional explanation is omitted.

The hybrid backlight apparatus of the present invention as set forth above adds light of a specific wavelength via a monochromatic light source such as a red LED to light of a white light lamp such as a fluorescent lamp, thereby adjusting the color coordinates and the color temperature of the mixed light to be close to daylight. In addition, the type of the supplementary light source, i.e., the monochromatic light source and the wavelength of the supplementary light can be optionally used to freely adjust the color range and the color temperature of the mixed light. When a specific monochromatic light source is added, the color expression range is widened and shifted toward the specific color of the monochromatic light source, enabling more natural color expression. In addition, such adjustment of the color temperature of the mixed light can be conducted at low costs without decreasing the output of light or undermining the reliability of the lamp.

While the present invention has been shown and described in connection with the preferred embodiments, it will be apparent to those skilled in the art that modifications and variations can be made without departing from the spirit and scope of the invention as defined by the appended claims.

What is claimed is:

1. A hybrid backlight apparatus comprising:
a main light source for generating white light;
a supplementary light source for generating monochromatic light to compensate color temperature of the white light of the main light source;
a light mixing region for mixing the white light with the monochromatic light to form mixed light with compensated color temperature; and
a reflection plate disposed underneath the light mixing region.

2. The hybrid backlight apparatus according to claim 1, wherein the white light has a color temperature ranging from 20000K to 7000K, and the supplementary light source generates the supplementary light to have a color temperature ranging from 12000K to 5000K.

3. The hybrid backlight apparatus according to claim 1, wherein the main light source comprises a fluorescent lamp.

4. The hybrid backlight apparatus according to claim 1, wherein the monochromatic light is red light.

5. The hybrid backlight apparatus according to claim 4, wherein the supplementary light source comprises at least one selected from a group including a light emitting diode, a laser diode and a monochromatic filter lamp.

6. The hybrid backlight apparatus according to claim 4, wherein the output of the supplementary light source is 5% to 20% of the output of the main light source.

7. The hybrid backlight apparatus according to claim 1, wherein the monochromatic light is red light,
the backlight apparatus further comprising a second supplementary light source for generating green light to mix with the mixed light.

8. The hybrid backlight apparatus according to claim 7, wherein the second supplementary light source comprises at least one selected from a group including a light emitting diode, a laser, a laser diode, a monochromatic filter lamp.

9. The hybrid backlight apparatus according to claim 1, wherein the light mixing region comprises a light guide plate, and the main light source and the supplementary light source are disposed at an edge of the light guide plate.

10. The hybrid backlight apparatus according to claim 9, wherein the main light source and the supplementary light source are disposed at different edges of the light guide plate.

11. The hybrid backlight apparatus according to claim 9, wherein the main light source and the supplementary light source are disposed at the same edge of the light guide plate.

12. The hybrid backlight apparatus according to claim 1, further comprising a housing which forms the light mixing region along with the reflection plate, wherein the main light source and the supplementary light source are disposed in the housing.

13. The hybrid backlight apparatus according to claim 12, wherein the main light source is supported by a side wall of the housing.
